(19) United States
(12) Patent Application Publication
(10) Pub. No.: US 2007/0130040 A1
(43) Pub. Date: Jun. 7, 2007

(54) Method for selecting media products not widely known to the public at large for investment and development

(76) Inventor: Brent Stinski, New York, NY (US)

Correspondence Address: MCKEE, VOORHEES & SEASE, P.L.C., 801 GRAND AVENUE, SUITE 3200, DES MOINES, IA, 50309-2721, US

(21) Appl. No.: 11/291,559

(22) Filed: Dec. 1, 2005

(51) Int. Cl. G06Q 40/00

(52) U.S. Cl. 705/36 R

(57) ABSTRACT

A method of determining, for purposes of development or investment, information about one or more media products not yet widely known to the consuming public. The method includes making a representation of each of the candidate media products available to a plurality of evaluators, providing a forum for the plurality of evaluators to engage in a futures trading process in which a market sponsor rewards evaluators for correct predictions of the future market performance of said candidate media products and penalizes evaluators for incorrect predictions of the future market performance of said candidate media products, and determining an aggregate representation of evaluators' predictions as to probable levels of future market performance of the candidate products using prices resulting from the futures trading process.

### BACKGROUND OF THE INVENTION

The invention relates generally to the prediction of future market or financial performance of various media products not widely known to the public at large, for means of investment in, and development and distribution of, those products.

All artistic and entertainment industries face one, crucial investment decision —which media products to invest in, develop, and distribute to the public, and which to leave behind. Such industries usually make these selections based on predictions of the potential future market performance of a given product—for example, how many copies a book will sell, or what kind of ratings a television show will receive. (These products may include book manuscripts, recorded music, video games, films, and television works, but which also include, without being limited to, products such ad campaigns, magazine articles, written music, visual images, music videos, comic strips, graphic novels, and more.) And this central task—selecting the right products, based on predictions of success—is clearly one of the most important challenges media industries ever undertake. Their profits in great measure rest on the question of whether these selections will prove wise, and whether predictions will prove to be correct.

But media industries struggle greatly to predict the performance of media products. Generally, several individuals in various guises—producers, editors, executives, talent scouts, and agents (for purposes here, “talent-selectors”)—combine their efforts to select media products that, they hope, will generate revenue, perhaps via future sales, advertising, or royalties. Often they are wrong. Media industries distribute many works that fail, and media industries pass over many works and artists that, once given a chance, succeed beyond expectation.

Every year, the media industry is filled with examples of failure—of films, books, television series, and musical recordings, produced and promoted at great expense, that are not embraced by the public. Film history furnishes the most startling examples, such as Heaven's Gate and Ishtar, which lost their creators more than $40 million each. In recent history, the 2005 film The Island cost $126 million to produce, but received only $35 million in domestic box office receipts. On Broadway, the 1988 musical Carrie lost its producers $7 million, and more recently the 2004 musical Taboo lost $10 million. In the publishing, music, and video game industries, a majority of released products simply never recoup their initial investment. All of the creators of these media products, at some point, had the opportunity to select an alternative project for investment and distribution.

Every year, media industries hesitate to distribute the work of many artists and other producers of media products. But, once given an opportunity, these products go on to earn unexpectedly high returns. Examples are almost too numerous to cite. In film, we witness stunning examples of recent missed opportunities, as studios hesitated to release films like The Passion of the Christ or Fahrenheit 9/11, both of which went on to realize record—setting profits. In music, bands like R. E. M. and Nirvana struggled to disseminate their music widely, before receiving major label contracts and growing immensely popular with the general public. Recent publishing successes such as Cold Mountain and The Lovely Bones certainly were not expected to perform as well as they did. And the problem is not new, as Jane Austen, Nathaniel Hawthorne, and Franz Schubert alike struggled to publish their work. In all of these examples there was a point where media investors could have chosen to promote undiscovered, high-value works—and the opportunity was missed.

Fundamental and long-standing aspects of media industries contribute to this state of bad investments and missed opportunities. One problem, in any media industry, is that traditionally only a limited number of talent-selectors evaluate any given product. Often up to a few dozen people are involved in the selection of films and music recordings. In publishing, a small handful may choose which books to publish, and which to pass over. And yet it is a tall order to ask a few individuals to predict how millions of consumers will respond to any given product. Inevitably, those evaluators are limited by their own tastes and preferences. They are further limited by their own incomplete knowledge of the marketplace. Lastly, they are limited by additional pressures—pressures to recommend certain products, say, out of allegiance to fellow workers, or to a particular artist. One way of addressing this predicament, of course, would be to distribute media products to as wide a body of evaluators as possible, mitigating individual fallibility. Still, in the media industry no device exists for officiating such a body, and for coordinating and reconciling its diverse opinions in an orderly and precise manner.

In another consideration, talent-selectors must sift through a massive quantity of candidate products for promotion and dissemination. In America a great number—perhaps millions—of musicians, authors, and directors, collectively create untold recordings, books, and films. Given such a quantity of products, talent-selectors often have little time to devote to evaluating each candidate. Indeed, as a common practice, media industries often delegate the task of “screening” candidates to less qualified individuals such as assistants or interns, a practice that contributes to chronic poor evaluation of the potential future performance of media products. Notably, again, a larger body of talent-selectors working in concert would be more likely to overcome this difficulty, since it could evaluate a large volume of material. Still, no method exists at present for coordinating such a body and exploiting its collective wisdom.

As a final consideration, institutional inertia and risk-aversion often rob talent-selectors and support entities of the flexibility and imagination to select, and invest in, the new and innovative material that often reaps the highest financial rewards. Record companies, as noted above, at one point deemed bands like R. E. M. and Nirvana too unconventional for widespread distribution—a theory mainstream audiences readily disproved. Well-known movie executives found The Passion of the Christ to be bizarre, and others considered the Oscar-winning Shakespeare in Love to be too focused on a narrow audience. These are remarkable mistakes. Still, one can see why they are made. Under immense pressure to achieve financial returns, media decision-makers find it safer to put their money behind, say, yet another cliched action film, or a conventional pop record, or a supermarket romance novel. These works often perform moderately well, one must grant. Still they almost never reach the high level of sustained profitability achieved by new and innovative works that go on to become classics.

Of course, traditional sectors of the media industry have attempted to address these shortcomings. The film industry has long consulted so-called “test audiences,” but with questionable results. Famously, test audiences did not respond well to E. T., the second highest grossing film of all time. Test audiences in 1939 felt that Judy Garland singing “Somewhere over the Rainbow” somehow slowed down The Wizard of Oz. For profound structural reasons, test audiences remain perennially controversial in the industry. Test audiences generally operate by surveying audience members as to what they like about a film, e.g. whether the ending satisfied them, or whether they thought a subplot needed more development. The problem is that run-of-the-mill audiences are not professional filmmakers—and many in the industry do not feel that their recommendations actually improve the film in question. Moreover, since a film has one chance at release, one can never verify the question of whether test-audience revisions actually improve sales. According to CNN, director Robert Altman, whose successful films include Gosford Park, The Player, and M*A*S*H says “It's a process that I don't believe in.” Test audiences remain controversial in publishing, television, and other media industries as well.

Thus considerable shortcomings have been exhibited in the prior art of a key function in all media industries—selecting proper media products for investment, based on a prediction of their potential success. Media industries, perhaps, have come to accept such limitations. Lacking any alternative, they accept an unwritten rule that selecting and investing in a work is merely a gamble. Talent selectors “go with their gut” in developing some film ideas or book proposals and not others. But in operating in such a manner, the prior art of talent-selection lives with chronic shortcomings, shortcomings my method will address in dramatic fashion.

Some recent internet-based schemes have attempted to address these shortcomings in the prior art. For example, U.S. Pat. No. 6,578,008 to Chacker discusses a global website whereby artists can freely upload artistic products to a website, and whereby website users worldwide can register feedback as to which artist is best. Chacker recommends that an “opinion poll” and a “virtual stock market game” be employed to measure users' various levels of approval.

The method exhibits notable weaknesses. For one, a prime feature of Chacker, online opinion polls, are not an optimal instrument for collecting aggregate opinions. Since poll respondents have no material incentive to tell the truth, poll respondents may praise artists casually and without serious thought, or merely because they wish to help the artist in question. Moreover, in opinion polls all respondents receive an equal say—each participant receives one vote, and a participant who feels that they have special information as to the potential success or failure of a given work cannot voice his or her opinion more emphatically than other participants. Such limitations make opinion polls a blunt instrument at best.

Chacker also proposes to employ a “virtual stock market game” as a means to allow web-site users to select high-value artists and models for promotion. It would appear that in such a game users would buy “virtual stock” in an individual (say, a musician or actor). Following traditional norms of stock market trading, one surmises, individuals profit in the game by way of selling stock in a given musician after its price rises, presumably due to increased demand of buyers in the virtual market. This is well and good, but this instrument too is also blunt. In particular, the virtual stock market above limits itself to telling us whether users prefer a given actor, musician, or fashion model—but it does not offer media decision-makers any detailed information a given embodiment of an artist's work, an actual product. Thus a virtual stock market says, “Brad Pitt: good!” or “Pat Sajak: boo!” But it does not tell us how many tickets Mr. Pitt's next film will sell, or whether an album of Mr. Sajak's love ballads might enjoy significant success. In this manner Chacker fails to address the real, day-to-day questions media decision-makers face.

In Chacker the web-site sponsor displays artists' work to the “general consuming public,” hoping later to engage highly praised artists “in contracts . . . based on said consumer feedback.” The problem with such an approach is that the web-site sponsor, clearly, must at some point make artists' products available to the public as a whole—if only so as to receive their evaluation of the artist in question. Once that happens, though, nothing in the claims of Chacker protects that website sponsor from outside competition to sign those very artists the website helps to publicize. Thus if Pat Sajak performs well in the online opinion polls and virtual stock market games envisioned by Chacker, then Mr. Sajak can, at any time, sign a contract with another, traditional talent agency or record company—a shortcoming that cuts the website host off from sharing in future profits generated by Mr. Sajak and his artistic works. Such a result is undesirable.

Another area in the prior art which may not seem related to Chacker without having the benefit of this disclosure is futures trading practices, or “prediction markets.” For purposes here “prediction markets” are a number of organizations that apply long-established futures trading practices in new and unconventional ways. These markets will be distinguished from traditional futures markets, such as the Chicago Mercantile Exchange, insofar as prediction markets, with small exceptions, often do not trade in contracts linked to commodities, such as corn or gasoline. Moreover prediction markets, for regulatory reasons, often do not trade directly in real money in an openly accessible, for-profit public forum—some are run as online games, while others are run as educational tools. In general, however, prediction markets do share a common quality: they use real or simulated futures trading practices to forecast outcomes not normally addressed by traditional commodities markets. In this regard predictive futures markets run by the Iowa Electronic Markets (IEM) have sought to forecast the presidential vote share, and Google has employed predictive markets to guide internal corporate decision making. Overwhelmingly these markets (with small exceptions) are often not regulated by the Commodities Futures Trade Commission (CFTC), as are traditional markets like the Chicago Mercantile Exchange.

One must note that these markets do indeed confirm the remarkable power of futures trading practices to forecast the outcome of uncertain future events. For years the IEM has more accurately forecasted presidential vote share than the AP and Gallup Polls—in the 2004 election the IEM yielded a margin of error of only 1.5 percent, as compared to 2.1 percent for the Gallup Poll. The German conglomerate Siemens employed an internal market to forecast—correctly—that the company would fail to deliver a software project on time. And a joint-venture between Goldman Sachs and Deutsche Bank has used markets to predict economic indicators, the results of which have been as accurate as economists' median forecasts. Hoping to harness the predictive power of futures markets, the Pentagon in 2002 famously proposed creating a “terrorism futures market” forecasting the likelihood of various attacks.

Still, it is important to distinguish the prior art of prediction markets from the method described in this patent application. For one, no prediction market has ever sought to select high-potential media products(from a broad body of candidates) for development and investment. Moreover none has ever attempted to generate profits in the same manner as does my method.

To be sure, some prediction markets have focused on limited aspects of media industries. But we quickly see that these markets, whatever their purpose, do nothing to directly address the problem of selection. For example the Hollywood Stock Exchange (HSX.com) enables users to trade “virtual stock” in films about to be released to the general public. A “stock market” in name only, the website functions in actuality as a predictive futures market, insofar as virtual trading rewards participants' correct predictions of ticket-sales and penalizes their incorrect ones. Still, one immediately observes, once films come to HSX.com for trading, film studios have already invested dozens, if not hundreds, of millions in them. Clearly, HSX.com does nothing to help the industry to choose which films are actually worthy of development and distribution in the first place, and as such does not really address the prior art of selecting candidate film ideas and predicting their potential success.

Other prediction market web-sites touch on entertainment-related themes as well, but, like HSX.com, they do not aid selection and prediction. A notable example is a game web site, Foresight Exchange. In general Foresight Exchange allows game trading in contracts linked to any number of questions, e.g., how many hurricanes will strike Florida in a given year, or whether a Supreme Court nominee will receive confirmation in the Senate. In this vein, Foresight Exchange has asked its players which television shows will receive the highest ratings, or which candidate will win an Oscar. Indeed these same types of questions are addressed by another game provider, Newsfutures.com, and a for-profit web site situated in Ireland, InTrade.com. In all such examples, though, prediction markets merely speculate on events in the entertainment industry—only ever addressing, like HSX.com, products that have already been discovered, invested in, and produced. Thus no existing prediction market has ever “put the market to work” by using a futures trading process to direct product selection, and investment.

In general, the prior art of talent-selection in traditional media industries has exhibited marked shortcomings. Recent attempts at improving upon this prior art, as in Chacker, have failed to address these shortcomings significantly, or in the manner described in my method. Looking the nascent field of prediction markets, we see that, despite the remarkable potential of prediction markets, no example in the prior art has ever harnessed markets to address problems of selecting the best candidate products for investment and development, as my method will.

Therefore, we see a remarkable, chronic problem: to this day, media industries regularly invest heavily in products that fail, while regularly passing over products with a high potential for success. Indeed one senses that media industries merely have come to accept such shortcomings, perhaps out of custom, perhaps out of a lack of any feasible alternative. It is a situation they need no longer accept.

### BRIEF SUMMARY OF THE INVENTION

Therefore, it is a primary object, feature, or advantage of the present invention to improve upon the state of the art.

Another object, feature or advantage of the present invention is to distribute products to be evaluated to a body of evaluators as opposed to the consuming public at large.

Yet another object, feature, or advantage of the present invention is to secure some form of representation rights in advance before submitting an artist or media product to a body of evaluators.

A further object, feature, or advantage of the present invention is to introduce into the process of evaluating media products for investment, promotion, and distribution, a method of evaluating the probability of future events using futures trading practices.

A still further object, feature, or advantage of the present invention is to assist in the discovery of high-value products not yet known to the public at large.

Another object, feature, or advantage of the present invention is to separate high-value products from a potentially broad body of competing candidates with a lesser potential for success.

Yet another object, feature, or advantage of the present invention is to open the process of evaluating potential future success of various media products to a broader body of evaluators, as opposed to a smaller, fallible group of individuals.

A still further object, feature, or advantage of the present invention is to solicit evaluators' true opinions by linking their choices directly and explicitly to potential loss or gain in a futures trading practice, as opposed to a more fallible practice such as an opinion poll.

Another object, feature, or advantage of the present invention is to aggregate evaluators' best predictions as to the likelihood of future success (such as a song selling a particular number of units or a book selling a certain number of copies) in the form of precise numerical recommendations, as opposed to subjective recommendations.

Yet another object, feature, or advantage of the present invention is to use appropriate predictions to prevent unwise investment in products that do not have a high likelihood of future success.

A further object, feature, or advantage of the present invention is to allow businesses to profit from a superior method of discovering high-value products not yet known to the public at large, enabling such businesses to profit from such discoveries by, for example,
a. acquiring rights to traded products before producing and distributing selected, high-value media products to a wider audience, or
b. acquiring rights to all traded products and selling rights to selected, high-value products to a third-party support entity, or
c. to make, for a fee, predictions of potential future success of products to which a business does not own rights.

Another object, feature, or advantage of the present invention is to enable talent-selection via global networks or a company-wide intranet, thereby reducing the cost of running an organization engaged in this task.

Yet another object, feature, or advantage of the present invention is to provide for querying individual talent-selectors in a one-to-one fashion, thereby mitigating conformity.

A further object, feature, or advantage of the present invention is to provide for aiding support entities in measuring strategic levels of investment of a high-value product, for instance, how much to spend on a resultant marketing campaign, or what kind of marketing campaign to run,.

A still further object, feature, or advantage of the present invention is to provide for aiding support entities in learning more about who is likely to approve of a given work, by revealing demographic information how certain groups traders tended to evaluate given products (for example, 20-29 year olds traded highly in the product, but 40-49 year olds did not).

One or more of these and/or other objects, features, or advantages of the present invention will become apparent from the specification and claims that follow.

In accordance with the invention a range of media products, not yet widely known by the general public, are presented to a body of evaluators, who trade in futures contracts linked to various levels of those products' potential future market performance. Such trading generates numeric predictions of the likelihood of eventual market performance, predictions which can dictate appropriate levels of investment, whereby a market sponsor can produce and distribute high-value items for business profit, or pass these on to other companies for such a purpose.

According to one aspect of the present invention, a method is provided for determining, for purposes of development or investment, information about one or more media products not yet widely known to the consuming public. The method includes making a representation of each of the candidate media products available to a plurality of evaluators, providing a forum for the plurality of evaluators to engage in a futures trading process in which a market sponsor rewards evaluators for correct predictions of the future market performance of the candidate media products and penalizes evaluators for incorrect predictions of the future market performance of the candidate media products, and determining an aggregate representation of evaluators' predictions as to probable levels of future market performance of the candidate products using prices resulting from the futures trading process. The method may further include applying the aggregate representation to one more investment and development decisions in accordance with the probable future market performance of the candidate media products. The step of determining may be performed by a computer. Preferably, the predetermined plurality of evaluators have access to the candidate media products over a global computer network.

Preferably, the method also includes obtaining representation rights for the market sponsor to the candidate media products before making the candidate media products available to the plurality of evaluators. The market sponsor may use the evaluators'aggregate representation of the probable levels of future market performance of the candidate products so as to persuade third party entities to invest in and distribute some or all of the candidate media products. The market sponsor may use the evaluators' aggregate representation of the probable levels of future market performance of the candidate products as a guide for decisions of whether itself to invest in and distribute the media product. The futures trading process may be conducted to evaluate, for a third party, candidate media products to which the market sponsor does not have representative rights.

According to another aspect of the invention, a system is provided for determining the potential future market performance of candidate media products not yet widely known to the consuming public at large. The system is operated by a market sponsor, and includes: a web site; a product database holding a plurality of media products under consideration, with additional background information regarding the works and their creators; a trader database holding information on a plurality of evaluators and their past trading activity in a futures trading process; and a market database and engine governing a futures trading process in which evaluators evaluate a plurality of media products. The web site is adapted for storing the media product information in the product database, storing the evaluators' trading activity in the trading database, storing market trading information in the market database. The product database is searchable by the evaluators. The market database and engine are utilized for transacting and recording evaluators' trades in various contracts, thereby enabling evaluators to make an aggregate prediction as to the probable future market performance of candidate media products, thereby enabling decisions of investment and development in accordance with the evaluators' aggregate prediction of probable future market performance.

### BRIEF DESCRIPTION OF THE DRAWINGS

FIG. 1 illustrates an overview of one embodiment of a system of the present invention.

FIG. 2 is a diagram showing one embodiment of the present invention.

FIG. 3 is a diagram another embodiment of the present invention.

FIG. 4 is a diagram illustrating another embodiment of the present invention.

FIG. 5 is a diagram illustrating another embodiment of the present invention.

FIG. 6 is a diagram illustrating another embodiment of the present invention.

FIG. 7 is a diagram illustrating one embodiment of a system of the present invention.

### DETAILED DESCRIPTION OF THE PREFERRED EMBODIMENT

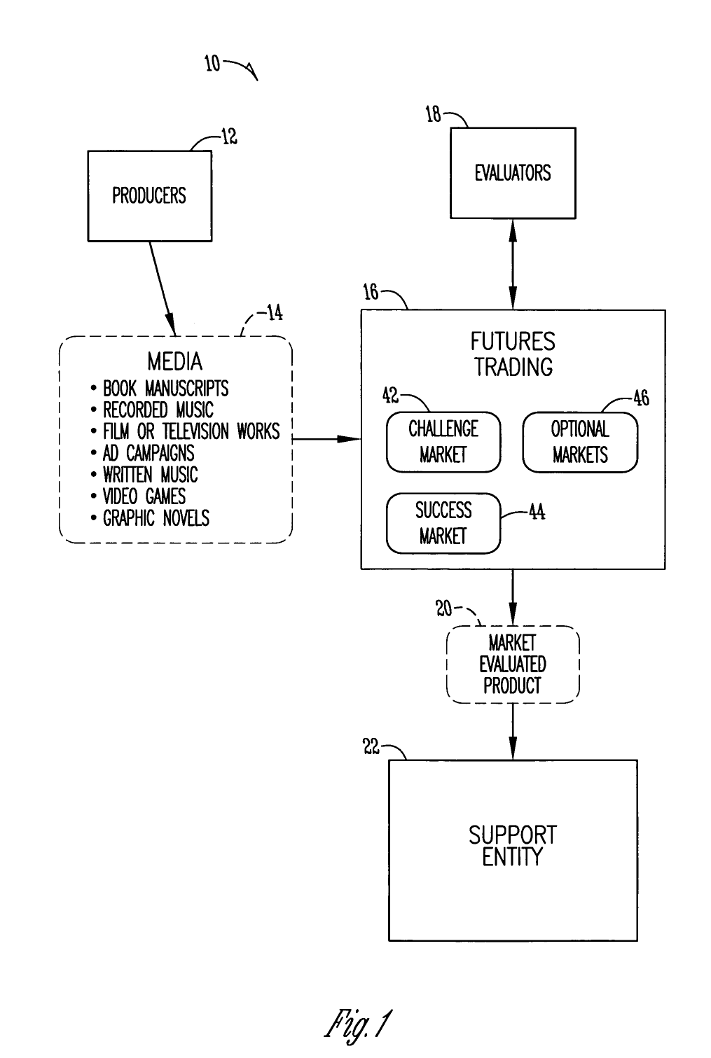

FIG. 1 illustrates one embodiment of a system 10 of the present invention. As shown in FIG. 1, producers 12 create media products 14. Examples of media products include, without limitation, book manuscripts, recorded music, film or television works, television pilots, ad campaigns, written music, video games, graphic novels, and other literary works, recordings, or performances. The media products 14 are submitted to a futures trading subsystem 16. The futures trading subsystem 16 can include a challenge market 42, a success market 44, as well as one or more optional markets 46, Evaluators 18 interact with the futures trading subsystem 16 to participate in trading activity. Based on the results of market trading, market-evaluated products 20 may be released such as to a support entity 22. The support entity 22 can be a book publisher, record company, film studio or other entity that is engaged in producing or distributing media products or is otherwise interested in the outcome of one or more futures trading markets.

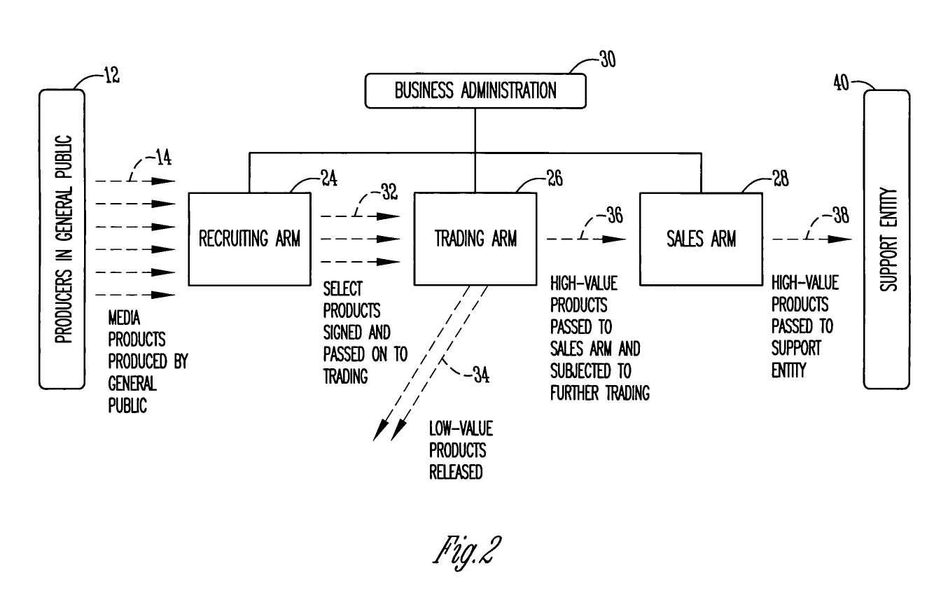

The methodology of the present invention can be implemented to support many different business models. FIG. 2 illustrates how the present invention is used in one business model. As shown in FIG. 2, the methodology is deployed by a business entity which includes a recruiting arm 24, a trading arm 26, a sales arm 28 and business administration 30. Members of the general public 12 produce various candidate media items 14, usually in the form of book manuscripts, recorded music, films or television works, but which may also include other media products (such as ad campaigns, written music, video games, visual images, graphic novels, and more). The media products 14 are submitted to the recruiting arm 24.

The recruiting arm 24 or its representatives preferably secure rights to represent the media products 14 which are produced by members of the general public 12. Again these media products 14 include but are not limited to book manuscripts, recorded music, and works for film and television, among many other possible products. Having secured rights, the business presents the media products 14 to a body of evaluators who, in this embodiment, act as employees of the business as a part of the trading arm 26. The recruiting arm 24 of the business seeks out candidate media products from the general public 12. Here the recruiting arm 24 need not function differently from traditional, prior-art methods for recruiting products for potential representation. For books, for example, the business can run a “slush pile,” whereby potential authors can submit unsolicited manuscripts, just as they would to a normal literary agency. For music, agents may conform to industry norms, whereby “talent scouts” actively seek out potential acts for representation. No matter what the method of recruitment, however, in such a business model, the business from the outset secures some form of representation rights to the media product in question, the importance of which is later discussed.

Generally such a business engages in talent selection. Indeed, in some regards, the business resembles others organizations traditionally engaged in seeking out high-value media products for eventual distribution by other sectors of the media industry. Of course, the individuals involved in these tasks, “talent-selectors,” vary from industry to industry—they may be agents, talent-scouts, producers and editors, and more. Still, all talent-selectors seek to achieve a common goal: they hope to assist producers of media products in bringing their works before the public, for the financial gain of all parties involved. And that requires selecting products that, talent-selectors predict, will perform well in the marketplace. Still, the business here improves upon the prior art of talent selection in one crucial aspect, by employing a superior method to predict the relative level of future success of media products under consideration through use of the trading arm 26 which uses futures trading.

Importantly, again, in this particular embodiment the business signs all considered media products for a limited period of representation. Without such rights in place, clearly, the business has no special claim on the high-value products it will eventually discover—artists who perform well in our markets, simply, would be free to sign with another talent agency at any time. Generally the nature of representation rights will be flexible, and will vary from industry to industry. In some cases the rights might entitle the business to demand a fee from an eventual publisher, film studio, or record company—in others they might entitle the business to a share of future royalties. The nature of these agreements will likely be negotiated on a per-case basis.

The recruiting arm 24 selects products to pass on to the trading arm 26. The trading arm 26 includes a plurality of evaluators who, via futures trading processes, make an aggregate judgment as to the potential future market performance of the work in question, separating products with a high potential for future earnings from products with a lower potential. The business releases the rights of less promising works as indicated by arrow 34, but retains rights to more promising works 36, handing them on to a sales arm 28 who, for a fee or share or future royalties, passes the high-value products to one or more support entities 40 engaged in producing and distributing media products. Examples of a support entity include a publisher, record company, film studio or other entity which may be involved in distribution and/or marketing of the product. The business differs from traditional practices, we quickly see, in that the body of evaluators, engaging in a futures trading process, is responsible for predicting the potential market performance of candidate products—telling us which products are worthy of investment, and how much investment they should receive. Suffice to say for now that, after an initial period of evaluation, products with a low probability of any kind of market success are released from representation. Representation contracts, where used, are preferably structured so that products that do have a high probability of success may be retained f for a further period of representation and then subjected to further market trading. They are also passed on to a sales arm of the business 28, which will attempt to sell these products on for profit. It should be appreciated, however, that obtaining rights, where necessary, can be performed as needed at various stages of the process. However, acquiring such rights, or an option to acquire such rights for a high value work, will generally be obtainable on more favorable terms when acquired early on in the process.

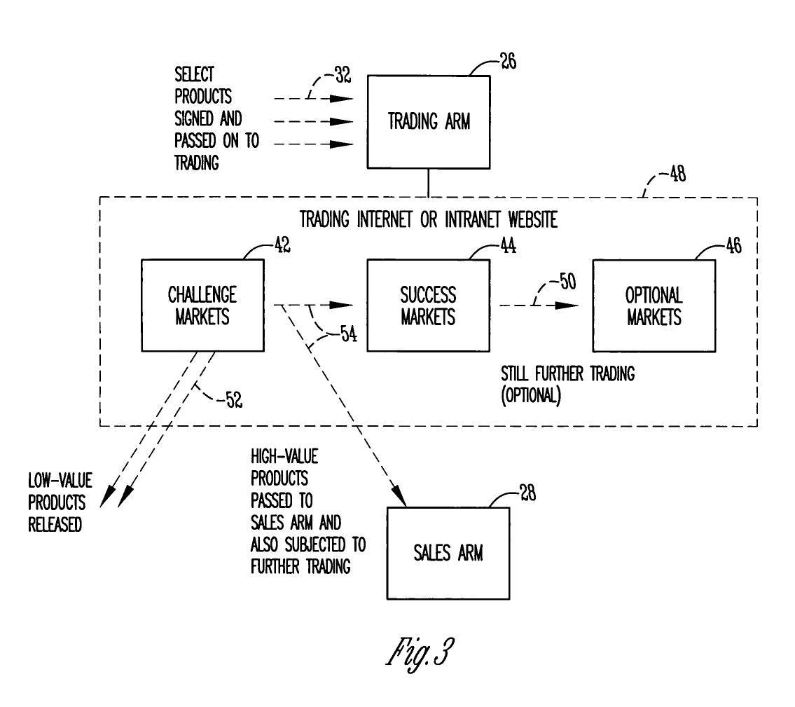

FIG. 3 illustrates in greater detail how the trading arm 26 uses futures trading. In FIG. 3, selected products 32 are signed and passed on to the trading arm 26. The trading arm 26 interacts with a trading web site 48. The trading web site 48 may be accessible over the internet, an intranet, or other type of computer network. It is not necessary that the trading take place using a web site, but this is preferred. The trading web site 48 shown includes a challenge market 42, a success market 44, and one or more optional markets 46. The challenge market 42 is used to separate low-value products 52 from potentially high value-products 54. The low-value products 52 are released while the high-value products 54 are passed to the sales arm 28 and also, preferably, subjected to further trading in the success markets 44. The decision can be made to provide for still further trading 50 in one or more optional markets 46.

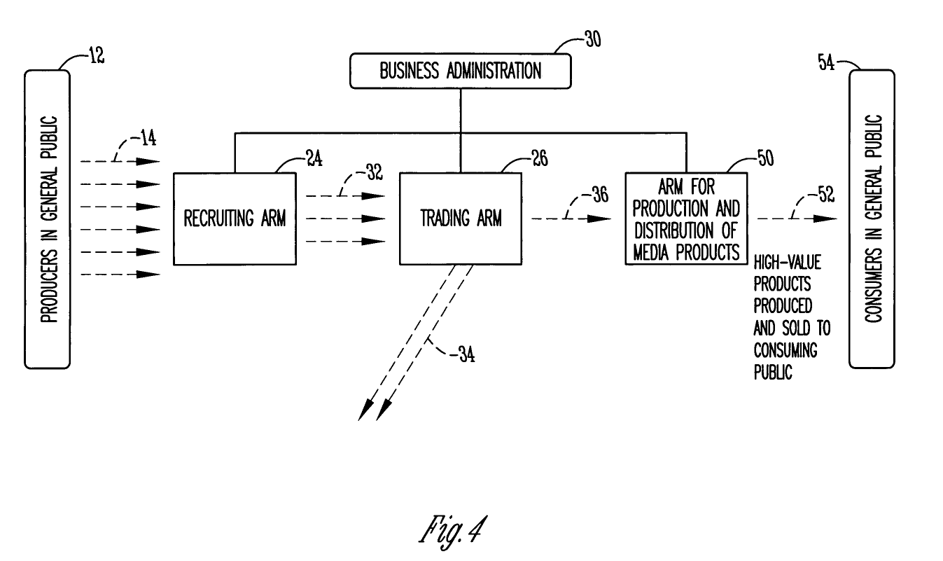

FIG. 4 illustrates one embodiment of a business model using the present invention. As shown in FIG. 4, producers 12 in the general public provide products 14 to the recruiting arm 24 of the business. The recruiting arm selects products 32 to be submitted to the trading arm 26 which releases low-value products 34 and ultimately selects high value products 36 to be released to a production/distribution arm 50. The high-value products produced 52 are then told to the consuming public 54.

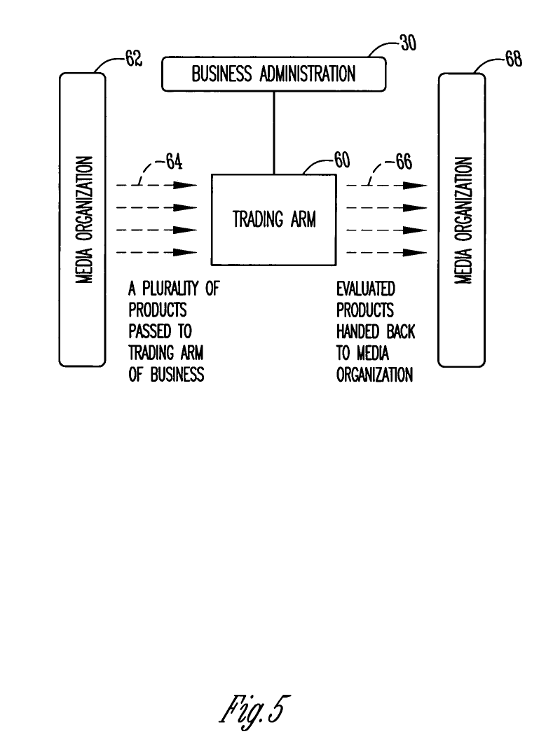

FIG. 5 illustrates another embodiment of a business model which can be used with the present invention. In FIG. 5, there is a media organization 62 which passes a plurality of products 64 to a trading arm 60. The trading arm evaluates the products 64 and passes the evaluated products 66 back to the media organization. Thus, according to this business model, the business need not obtain rights to any of the products or solicit buyers of products, but instead, the business merely acts as an evaluator of products.

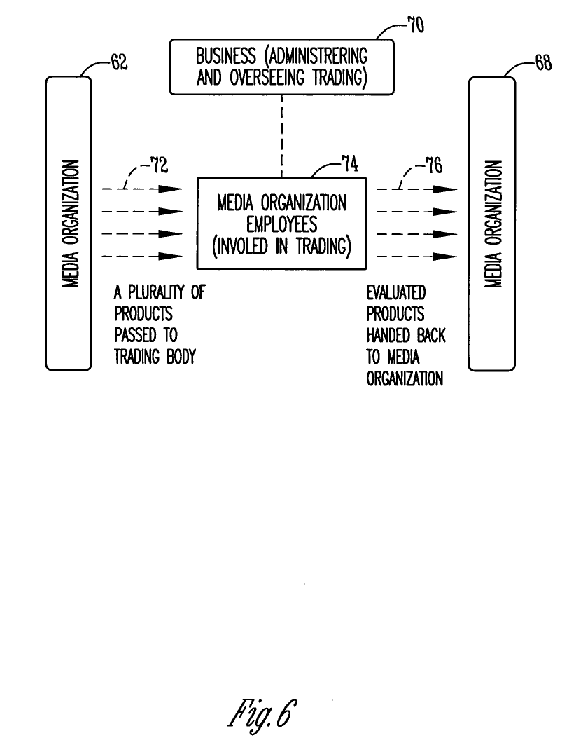

FIG. 6 illustrates another embodiment of a business model of the present invention. In FIG. 6, there is a media organization 62 which passes a plurality of products 72 for a trading body. A business 70 provides for administration and overseeing of trading over a trading body 74 which includes media organization employees who are involved in the trading. Evaluated products 76 are handed back to the media organization 68.

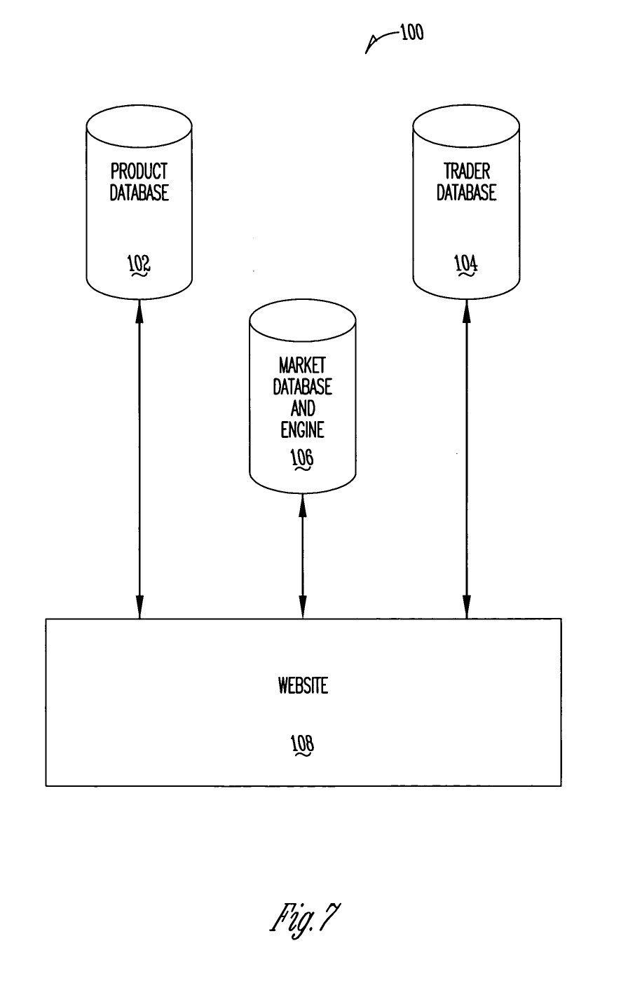

FIG. 7 illustrates one embodiment of a system 100 of the present invention. A product database 102, a trader database 104, and a market database and engine 106 are operatively connected to a web site 108. The system is adapted for determining the potential future market performance of candidate media products not yet widely known to the consuming public at large. Preferably, the system 100 is operated by a market sponsor. The product database 102 is adapted for holding a plurality of media products under consideration, with additional background information regarding the works and their creators. The trader database 104 is adapted for holding information on a plurality of evaluators and their past trading activity in a futures trading process. The market database and engine 106 are adapted for governing a futures trading process in which evaluators evaluate a plurality of media products. The web site 108 is adapted for storing the media product information in the product database 102, storing the evaluators' trading activity in the trader database 104, storing market trading information in the market database 106. The product database 102 is preferably searchable by the evaluators. The market database and engine 106 are utilized for transacting and recording evaluators' trades in various contracts, thereby enabling evaluators to make an aggregate prediction as to the probable future market performance of candidate media products, thereby enabling decisions of investment and development in accordance with the evaluators' aggregate prediction of probable future market performance.

Having previously reviewed some of the different business models which can be used to implement the present invention, let us now look more closely at the mechanics of how products are evaluated.

The key feature of any of these different business models is a futures trading forum, a prediction market, which I now consider in detail. Generally predictive futures markets operate on a “winner-take-all” basis. Suppose that a contract trades at a given price—say, $.60. If a trader purchases this contract, and the record contract is eventually awarded, then the contract is liquidated by the market sponsor at $1.00. If the event does not come to pass, it is worth nothing. With such a provision in place, futures markets gradually estimate the numeric likelihood of various outcomes: for a contract representing probable event (say, that a record will sell between 100,000-150,000 copies) prices will rise closer to $1.00, for example, to $0.75 or $0.80, as traders grow more confident that they will receive a return on their investment. For contracts representing less probable events (say, that a record will sell between 500,000-550,000 copies) prices will fall—to, say $0.20 or $0.30. In all cases demand drives prices—if traders foresee high sales, then demand will rise for contracts linked to higher levels of success, directly forcing up prices. That same action will also drive down prices for alternative contracts predicting lower sales, say, to $0.30 reflecting traders' belief that lower sales are unlikely. (Traders still may still take a risk on buying such contracts—since, on the outside chance this prediction comes true, the potential for profit is greater than if the trader invested in other contracts.) Conveniently, the market is arranged in such a matter that a price of a contract directly reflects traders' aggregate numeric prediction of the probability of the corresponding outcome—an $0.80 contract directly represents an 80 percent probability of that outcome actually happening.

Via such means, traders engage in an ongoing process gradually determining consensus, numerical predictions as to the likelihood of various outcomes to future events. In evaluating media products in this manner, traders eventually indicate what levels of investment, if any, will be appropriate for those products.

Let's look at a developed, real-world example. Again, in FIG. 3, we see a detailed model of the trading arm of the business. For purposes here, we consider examples from the publishing industry:
1) Unagented manuscripts are solicited from the general public, via recruitment or submission, as we might witness in a traditional literary agency.
2) As with a traditional literary agency, a conditional offer of representation is made to high-potential manuscripts; in this case the business secures sole representation rights to the manuscript for at least two months.
3) The business submits the manuscript to a winner-take-all “Challenge Market.”
   a. On an intranet or internet web site, the business creates a web page containing the manuscript (in part or in full) and also including information about the author (biography, links to other books written by the author, links to the author's website, and more), as well as all market data regarding trading with regard to the author's manuscript
   b. The Challenge Market allows trading in two contracts:
      i) Yes, the item in question will be signed and distributed, according to pre-established criteria (e.g. it will be published and twenty thousand copies will be distributed).
      ii) No, the item in question will not be distributed.
   c. If challenge “Yes” contracts finish trading above a certain price (e.g., above $0.75), then contracts will be designed so as to automatically extend exclusive representation to nine additional months.
   d. If the challenge “Yes” contracts do not finish trading above a certain price (e.g. below $0.75), then the business will release the manuscript author from any form of representation or legal obligation.
   e. Note that if at any point the manuscript is signed for distribution (in a manner meeting pre-established requirements), then traders' contracts in “Yes” are liquidated at $1 and “No” contracts at $0. If the manuscript is not signed after nine months, then in the market “No” contracts are liquidated at $1 and “Yes” at $0.

Continuing with the above example, we suppose that the manuscript in question trades “yes” over a pre-established price. Representation contracts are preferably structured such that the business automatically retains exclusive representation rights for the manuscript for an additional nine months. (Note that in general the business will agree to represent products, but not individuals. As such, the business will not engage in artist representation as would traditional literary agencies—say, by providing services to an author, or attempting to nurture the author's career as a whole. The business, however, will make the product attractive to publishers, thereby aiding the author's quest to get his work into print.)

During the nine months of additional representation, the business submits the manuscript to a winner-take-all “Success Market,” a market predicting how many units of the resulting book will be sold after the first twelve months of U.S. release. In the Success Market users will have the option to buy contracts according to a variety of gradations of market performance. Buyers of, say, “10k-50k” contracts predict that the book resulting from the manuscript will sell 10-50,000 units, while buyers of “50k-75k” contracts predict that the book will sell 50-75,000 units. Here users will have the option to trade “zero,” indicating a prediction that the manuscript will never make it to distribution.

Like Challenge Markets, Success Markets in all media (music, film, television and more) include detailed information about artists to aid traders in making investment choices. The business also educates non-professional users as to industry trends and reasonable expectations for sales volume (music traders will learn that Brittney Spears's latest record sold x units, The Rolling Stones' latest record sold y units, and so forth, so as to use these figures as points of comparison). Success Markets are cleared twelve months after initial U.S. release of the resulting manuscript. Pre-determined and objective industry sources for determining levels of sales are used to determine the volume of units sold, and contracts are liquidated accordingly. As before, contracts for the winning sales volume category (e.g. 10k-50k) will be liquidated at $1, and all other contracts will be liquidated at $0, thereby rewarding correct predictions and penalizing wrong ones.

The product of all of this trading? It furnishes a prediction of the potential market performance of a given product—a prediction made by the collective, self-interested intelligence of preferably hundreds, if not thousands, of evaluators. On the strength of such a prediction, the sales arm can attempt to persuade support entities to produce and distribute the product for a wider commercial audience, for a fee or for a share of future royalties, thereby generating revenue for the business as a whole.

Importantly, the methodology of the present invention does not place decisions in the hands of a small and fallible group of individuals, but rather in the hands of preferably hundreds or even thousands of evaluators. Thus, decision-making and evaluation are opened up to a broader body of evaluators. It is, however, preferable that some level of control is exercised over the evaluators. In one embodiment, the evaluators are employees or independent contractors. In such embodiment, the evaluators can be appropriately screened. Alternatively, the evaluators be may required to register.

The methodology of the present invention avoids mere subjective recommendations and the problems of the prior art as it yields numerical probabilities representing traders'best collective predictions as to the earning potential of given works. The business also departs from the prior art of prediction markets in the role of the prediction market relative to the business. Most commercial prediction markets, such as InTrade.com and HedgeStreet.com, profit mainly from transaction fees levied on their traders. But in great contrast, the guiding principle of the preferred business models is not to profit from transaction costs, but to acquire a stake in future earnings of potentially successful media products the market itself discovers.

The advantages of my method, we note, are not available in other forms of trading. While in a “virtual stock market” traders might invest in imaginary stock in an individual artist (as considered above in Chacker), futures markets more subtly enable traders the ability to trade in contracts linked to a wide variety of outcomes. Here, evaluators do not “invest” in the product itself, either via real or imaginary means, but in a “derivative,” a future event. As such, there is no limit to the number of potential questions that can be posed to evaluators. Traders can address not merely questions as to future sales, but also, for example, comparative questions, such as which one of five movies or music albums will perform the best over a given period of time. Where “stock market” models offer a blunt instrument, registering vague approval of a single individual, futures trading processes can be constantly fashioned to furnish ever more detailed judgments on ever more specific questions.

I also note that futures trading practices, unlike opinion polls or test audiences, subtly capture the true strength of traders' convictions. For example, traders can “weight” their voice in the marketplace. If a trader believes strongly in the future success of a given record, he or she will invest heavily—thereby having a corresponding influence on prices and predictions. If traders are uncertain, they invest less heavily, thereby lightening their influence. Moreover, in such a process, traders profit not merely from making correct predictions, but by pointing out the false predictions of other traders. Thus if some traders overvalue the potential of a certain record, book, or film, other traders can profit by buying competing contracts or “short selling” these contracts.

In yet another advantage, futures markets can flush out opinions that might not otherwise be expressed in an opinion poll. Suppose a trader has special knowledge as to why a given book manuscript or musical album will go on to be successful. For example, a book may address a topic that, the trader believes, will be of considerable public interest in the immediate future. Rather than sit quietly on this knowledge, the trader has an incentive to express his opinions early and in a public forum, enabling other traders to take this new information into account. In this regard, futures markets flexibly respond to events over time. As new opinions and data emerge, traders may reconsider and even reverse their original opinions, if they feel doing so is warranted.

All of these factors conduce to predictions of remarkable subtlety and accuracy. Indeed futures trading practices seemingly offer these advantages even if trading does not involve real money. According to Pennock, et al (Science, 2001), the inherent checks and balances of futures trading practices mean that even “game markets” offer predictions almost as accurate as those of “real-money” markets. Analyzing data from HSX.com and the Foresight Exchange, the study found that, game markets furnished relatively accurate predictions as to how much a movie might gross in its first month of release, or who might win an Oscar. Servan-Schreiber et al (Electronic Markets, 2004) compared NFL predictions from NewsFutures' simulated exchange to the real-money exchange of Tradesports, an exchange based in Ireland—finding that both exchanges performed equally well.

For these reasons, I use the term “futures trading process” throughout, to emphasize that following the mere rules and customs of futures trading is in itself sufficient to provide accurate market predictions. And this is an important consideration in that, under current CFTC regulatory conditions, it seems unlikely that a business could offer the public a traditional, real-money media futures exchange as, say, the Chicago Mercantile Exchange might offer futures trading in corn, oil, or pork. That said, the method described in the claims can be applied to other, legally acceptable manifestations, many of which involve trading with real value. In our present example, a business offers markets whereby employee-evaluators trade for bonuses or commissions, a legal practice well-established within the prior art. One might also run game markets where traders may trade for prizes or store credits. Ultimately the material nature of the forum need not matter here: futures trading practices, in any guise, produce accurate forecasts. Thus the method in the claims can be applied to both real-money and simulated markets with equal effect.

As indicated, a variety of alternative embodiments can take advantage of the method as well. In all such embodiments, the core method is used to sift through a large body of candidate products, predicting levels of market or financial performance, identifying those which have the greatest probability of achieving financial success, and thereby enabling appropriate decisions of selection and investment.

In FIG. 4, a single company takes advantages of the method described in the claims by subsuming all duties in the process of discovering, producing, and disseminating media products. In this model, the company gathers media products from the public at large, signs them for representation, and then produces, promotes, and distributes emergent high-value products on its own. Here, the media products under question can be gathered from the general public (e.g. books and music), or products produced collectively by the organization itself (e.g. ad campaigns or video games).

In FIG. 5, we see an alternative embodiment, in which support entities can consult a business and submit media products for consideration to that business's body of evaluators. The business adds value to the products by assessing their probable level of success—thereby enabling the third-party company to decide whether to invest in and develop such products or not. Once again, the media products under question can be gathered from the general public (e.g. books and music), or products produced collectively by the organization itself (e.g. ad campaigns or video games).

In FIG. 6, we see that a business can administer futures trading practices for a pool of evaluators not under a business's direct employment. Here, a business administers markets for employee-traders for another company on a consultancy basis. Another company takes advantage of the method described in the claims by acquiring rights to and later selecting, producing, and distributing high-value media products.

In all such embodiments, as noted, contracts in markets may or may be linked to real or simulated, “game” value, as both modes are generally successful in predicting future outcomes.

However it is applied, one has every reason to expect that my method will enable businesses to outperform, if not vastly, the prior art of selecting high-value products most worthy of investment, development, and distribution.

One reason is that, unlike prior art practices, futures markets are unbiased and unprejudiced—and therefore naturally resistant to manipulation, favoritism, or influence. In the prior art, we often see, talent-selectors may promote works out of allegiance to other evaluators, allegiance to a given artist, or mere subjective, but erroneous, preference for a given work. The futures market, however, corrects false predictions, whether they are made intentionally or not. As noted, if a number of traders teamed up to promote a friend's work—a work that in actuality had a low probability of future success—then other traders could easily profit from “short-selling” against this false recommendation, or buying alternative contracts that predict a lower rate of future success—thereby erasing the initial attempt to manipulate the market. In such an arrangement, traders, acting as individuals, must evaluate a work on its merit alone. They will be rewarded by the accuracy of their predictions—and nothing more.

In another advantage, evaluators themselves need not have special prior experience, or elaborate professional connections, in order to participate in the process of talent-selection. Evaluators needn't locate themselves in central hubs for media industries, such as New York or Los Angeles. And this is significant: by conducting market trading via electronic means (via the internet or a company-wide intranet) a business stands a better chance of drawing out the most skilled evaluators available in the general public as a whole, efficiently taking advantage of their wisdom, regardless of wherever, or whoever, they are.

In selling and promoting candidate products, though, the business enjoys its most stunning competitive advantage over its would-be competitors. Throughout history, talent-selectors have had little means of reassuring support entities of the earning potential of a given work—they have offered little more, and little less, than the authority of their own personal, subjective recommendations. But where traditional talent-selectors merely “go with their gut” in recommending some products over others, our talent selectors offer data: real numeric predictions as to the statistical probability that a given media product will go on to achieve a specific level of performance—say, that a book will have a 70% chance of selling between 10,000-50,000 copies. Thus investors and media decision makers can move ahead with greater confidence of success.

Thus, where once decisions rested in the hands of fallible individuals, futures markets will distill the best intelligence of thousands of minds. Where once personal and professional allegiances tainted the talent-selection process, now a dynamic, flexible, and unprejudiced market will be free to choose, at any point, whatever products it prefers—even the new and innovative material that traditional talent-selectors regularly overlook.

As a result, more than ever before in history, the media products that truly deserve to succeed will have their chance at distribution. More than ever before, media evaluators will be rewarded not for conservative group-think, but for the accuracy of their honest, individual judgments. The end result: more than ever before, media investors will know what they are really buying.

Accordingly the reader will see that I have provided a method for selecting high-value media products, by predicting the future success of media products unknown to the public at large. My method has additional advantages not listed in detail above:
enabling talent-selection via global networks or a company-wide intranet, thereby reducing the cost of running an organization engaged in this task,
querying individual talent-selectors in a one-to-one fashion, thereby mitigating conformity,
aiding support entities in measuring strategic levels of investment of a high-value product, for instance, how much to spend on a resultant marketing campaign, or what kind of marketing campaign to run,
aiding support entities in learning more about who is likely to approve of a given work, by revealing demographic information how certain groups traders tended to evaluate given products (e.g., 20-29 year olds traded highly in the product, but 40-49 year olds did not).

While the above description contains many specificities, these should not be construed as limitations on the scope of my method, but as exemplifications of the presently preferred embodiments thereof. Many other ramifications and variations are possible within the teachings of the invention. For example, there may be other business arrangements putting to use the method in the claims (whereby a futures trading practice is used to select high-value media products from a body of candidates). Moreover my method need not be limited to dealing in well-known media products, such as music, movies, or books, but could be applied to any form of communicative product distributed for entertainment or information purposes to the public as a whole, including but not limited to graphic novels, magazine articles, promotional campaigns, visual images, film shorts, dances, music videos, video games, as well as treatments of games, movies, television programs, among other examples. Thus the scope of the invention should be determined by the appended claims and their legal equivalents, and not by the examples given.

It is also observed that the markets above are described to operate with “winner-takes-all” contracts, in which a contract pays off at $1 if and only if a specific event occurs, such as a record selling a pre-established number of units. It is worth noting that prediction markets can be employed in any number of alternative ways.
In an “index” contract, the amount that the contract pays varies in a continuous way based on a number that rises or falls (e.g. comparative ratings of a television programs, or the percentage of the vote received by a presidential candidate).
Alternatively, in “spread” betting traders bid on the cutoff that determines whether an event occurs, such as whether one song will sell a certain number of singles more than another song released from the same album. (Or, in another example, in point-spread betting in football one wagers that a team will win by at least a certain number of points, or will not.)
Lastly, in variable trading, traders can buy “long” or “short” on various categories. Thus if a trader buys a contract that a book will sell between 20,000 and 30,000 copies, the trader might choose buy “long,” indicating a prediction that the ultimate number of sales will end up closer to 30,000 than to 20,000. Payouts are proportionally adjusted accordingly to reward these predictions: if final sales end up at 29,500 copies, the trader will be rewarded more than if they end up at, say, 23,000 copies.
Thus, the present invention contemplates numerous variations in the particular type of futures trading techniques.

It is further observed that significant value should be attributed to the methodology and system of the present invention where implemented. For example, all revenue associated with distribution of a product can be attributed to use of the present invention to determine that the product should be distributed. Similarly, there is significant value in the prevention of loss associated with using the methodology or system of the present invention to determine not to pursue a particular product.

To the extent any references have been identified herein, each of these references is incorporated in its entirety herein. Without further elaboration, the foregoing will so fully illustrate my invention that others may, by applying current or future knowledge, readily adopt the same for use under various conditions of service.

What is claimed is:

1. A method of determining, for purposes of development or investment, information about one or more media products not yet widely known to the consuming public, the method comprising:
making a representation of each of said candidate media products available to a plurality of evaluators;
providing a forum for said plurality of evaluators to engage in a futures trading process in which a market sponsor rewards evaluators for correct predictions of the future market performance of said candidate media products and penalizes evaluators for incorrect predictions of the future market performance of said candidate media products;
determining an aggregate representation of evaluators' predictions as to probable levels of future market performance of said candidate products using prices resulting from said futures trading process.

2. The method of claim 1 further comprising applying said aggregate representation to one more investment and development decisions in accordance with the probable future market performance of said candidate media products.

3. The method of claim 2 wherein the step of determining is performed by a computer.

4. The method of claim 3 wherein a predetermined plurality of evaluators have access to said candidate media products over a global computer network.

5. The method of claim 1 further comprising obtaining representation rights for the market sponsor to said candidate media products before making said candidate media products available to the plurality of evaluators.

6. The method of claim 1 wherein the market sponsor uses said evaluators' aggregate representation of the probable levels of future market performance of said candidate products so as to persuade third party entities to invest in and distribute some or all of said candidate media products.

7. The method of claim 1 wherein a market sponsor uses said evaluators' aggregate representation of the probable levels of future market performance of said candidate products as a guide for decisions of whether itself to invest in and distribute said media products.

8. The method of claim 1 wherein said futures trading process is conducted to evaluate, for a third party, candidate media products to which the market sponsor does not have representative rights.

9. The method of claim 1 wherein the representation of each of said candidate media products is an entire copy of each of said candidate media products.

10. The method of claim 1 wherein the representation of each of said candidate media products is a sample comprising a portion of the corresponding candidate media products.

11. The method of claim 1 wherein the representation of each of said candidate media products is a preliminary version of the corresponding media product.

12. The method of claim 1 further comprising distributing at least one of said candidate products at least partially based on the aggregate representation of evalutors' predictions as to probable levels of future market performance.

13. The method of claim 1 further comprising determining not to distribute at least one of said candidate products at least partially based on the aggregate representation of evaluators' predictions as to probable levels of future market performance.

14. The method of claim 1 wherein one of the purposes of investment is to determine whether or not to invest resources in further development of one of the media products.

15. A system for determining the potential future market performance of candidate media products not yet widely known to the consuming public at large, wherein said system is operated by a market sponsor, and said system comprising:
a web site;
a product database holding a plurality of media products under consideration, with additional background information regarding said works and their creators,
a trader database holding information on a plurality of evaluators and their past trading activity in a futures trading process;
a market database and engine governing a futures trading process in which evaluators evaluate a plurality of media products;
said web site storing said media product information in said product database, storing said evaluators' said trading activity in said trading database, storing market trading information in said market database, said product database being searchable by said evaluators, and wherein said market database and engine are utilized for transacting and recording evaluators' trades in various contracts, thereby enabling evaluators to make an aggregate prediction as to the probable future market performance of candidate media products, thereby enabling decisions of investment and development in accordance with said evaluators' aggregate prediction of probable future market performance.

16. A computer-assisted method of determining information about one or more media products not yet widely known to the consuming product, for purposes of development or investment, the method comprising:
making at least a portion of each of said candidate media products available to a plurality of evaluators over a computer network;
providing a forum accessible over the computer network for said plurality of evaluators to engage in a futures trading process in which a market sponsor rewards evaluators for correct predictions of the future market performance of said candidate media products and penalizes evaluators for incorrect predictions of the future market performance of said candidate media products;
determining using a computer, an aggregate representation of evaluators' predictions as to probable levels of future market performance of said candidate products using prices resulting from said futures trading process; and
applying said aggregate representation to one more investment and development decisions in accordance with the probable future market performance of said candidate media products.

17. The computer-assisted method of claim 16 wherein the portion of each of said candidate media products is a preliminary version.
